(19) United States
(12) Patent Application Publication
(10) Pub. No.: US 2003/0088768 A1
(43) Pub. Date: May 8, 2003

(54) Transmitting a broadcast via the internet within a limited distribution base of listeners

(75) Inventor: David Carroll Challener, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/016,792

(22) Filed: Nov. 2, 2001

(51) Int. Cl. H04L 9/00

(52) U.S. Cl. 713/163

(57) ABSTRACT

A method, system and computer program product for transmitting a broadcast over the Internet by a broadcaster where users located approximately within a defined distribution area of the broadcaster can receive or interpret the broadcast. A broadcaster may transmit an encrypted broadcast over the Internet while transmitting a decryption key to users of computer systems over the air within its defined distribution area. Only users that are located approximately within the defined distribution area of the broadcaster may receive the decryption key and hence be able to decrypt the encrypted broadcast. Furthermore, a broadcaster may receive a request from a user of a computer system to transmit a broadcast over the Internet to that user. Upon determining the approximate location of the user, the broadcaster may transmit the broadcast over the Internet to that user if that user is located approximately within the defined distribution area of the broadcaster.

### TECHNICAL FIELD

The present invention relates to the field of transmitting information over the Internet, and more particularly to a broadcaster, e.g., radio station, transmitting information, e.g., audio information, over the Internet to a limited distribution base of listeners thereby lessening the amount of copyright royalty fees the broadcaster may be required to pay.

### BACKGROUND INFORMATION

Radio stations may be used for transmitting information with the aid of electromagnetic waves. The frequency spectrum of the electromagnetic waves in question may typically extend from several hundred kilohertz (kHz) up to around a hundred megahertz (MHz). Each radio station is required to receive a license from the Federal Communications Commission (FCC) to broadcast radio signals within a defined distribution area defined by the terms of the license.

With the advent of the Internet, radio broadcasters have subsequently encoded the radio broadcast into digital packets which may then be transmitted through the Internet to various computer users throughout the world. The computer users may then be able to listen to the radio broadcast via speakers on their computer systems. It may be desirable to transmit a radio broadcast over the Internet to improve the quality of the radio broadcast since the broadcast is transmitted over the Internet in digital form instead of audio form (that is, an analog audio modulation) as is the case when the radio broadcast is transmitted over the air. Furthermore, by broadcasting radio signals over the Internet in digital form, the broadcast is readily amenable to formatting in a visual rendition, thereby allowing a hearing impaired person to visually see the words of the radio broadcast stream in front of him/her.

Radio stations may be required to pay copyright royalties based on the estimated number of listeners which in turn depends on the coverage of the radio broadcast. Furthermore, the amount of money a radio station may be required to pay a disk jockey may also be based on the estimated number of listeners which in turn depends on the coverage of the radio broadcast. Subsequently, radio stations may decide not to transmit radio broadcasts over the Internet because the radio signal may be transmitted all over the world. That is, radio stations may decide not to transmit radio broadcasts over the Internet because the royalty fees may be too large since the estimated number of listeners may be too large.

It would therefore be desirable to enable broadcasters, e.g., radio stations, to transmit information, e.g., audio information, over the Internet to a smaller distribution base of listeners thereby lessening the amount of copyright royalty fees the broadcaster may be required to pay.

### SUMMARY

The problems outlined above may at least in part be solved in some embodiments by a broadcaster transmitting an encrypted broadcast over the Internet while transmitting a decryption key to users, i.e., users of computer systems, over the air within a particular defined distribution area of the broadcaster. The defined distribution area may be established by the broadcaster as to establish the approximate number of listeners and therefore establish the approximate amount of copyright royalties the broadcaster may be required to pay. Only users that are located approximately within the particular defined distribution area of the broadcaster may be able to receive the decryption key and hence be able to decrypt the encrypted broadcast. In another embodiment of the present invention, a broadcaster may determine the approximate physical location of a user, i.e., a user of a computer system. If the user is located approximately within a particular defined distribution area of the broadcaster, the broadcaster may transmit the broadcast over the Internet to that user.

In one embodiment of the present invention, a method for transmitting a broadcast over the Internet by a broadcaster where the broadcast is interpreted by users located approximately within a defined distribution area of the broadcast may comprise the step of encoding a radio broadcast into digital packets of information. The digital packets of information may then be encrypted and subsequently transmitted over the Internet. The broadcaster, e.g., radio station, may further broadcast a decryption key via a transmitter over the air within the defined distribution area of the broadcaster. The defined distribution area may be established by the broadcaster as to establish the approximate number of listeners and therefore establish the approximate amount of copyright royalties the broadcaster may be required to pay. Users, i.e., users of computer systems, that are located approximately within the defined distribution area of the broadcaster may receive the decryption key via a radio receiver card within their computer system. Upon receiving the decryption key, those users may decrypt the receive encrypted digital packets of information. Upon decrypting the encrypted digital broadcast, the decrypted digital broadcast may be reproduced by an audio transducer thereby allowing the user to listen to the digital broadcast. Thus, a broadcaster, e.g., radio station, may be able to transmit a radio broadcast over the Internet and ensure that users that are located approximately within a defined distribution area of the broadcaster will be able to listen to the transmitted digital broadcast. By ensuring that only users located approximately within the defined distribution area of the broadcaster may be able to listen to the broadcast over the Internet, the distribution base of listeners listening to the broadcast over the Internet may be limited and subsequently lessening the amount of copyright royalty fees the broadcaster may be required to pay.

In another embodiment of the present invention, a method for enabling broadcasters, e.g., radio stations, to transmit information, e.g., audio information, over the Internet within a defined distribution area may comprise the step of a server broadcaster, e.g., radio station, receiving a request to transmit a broadcast over the Internet from a user of a computer system. The server broadcaster may then determine an approximate physical location of the requester. The location of the requester may be approximately determined by the server broadcaster capturing the Internet Protocol (IP) address of the requester. Upon capturing the IP address of the requester, the server broadcaster may convert the captured IP address of the requester into a computer name, e.g., convert 206.156.18.122 into www.consumer.net. Upon converting the IP address of the requester into a computer name, a trace may be performed to determine the approximate physical location of the requester. The server broadcaster may then determine if the requester is located approximately within the defined distribution area of the server broadcaster. The defined distribution area may be established by the broadcaster as to establish the approximate number of listeners and therefore establish the approximate amount of copyright royalties the broadcaster may be required to pay. If the requester is located approximately within the defined distribution area of the server broadcaster, then the server broadcaster may transmit the requested digital broadcast to the requester. If the requester is not located approximately within the defined distribution area of the server broadcaster, then the server broadcaster may not transmit the requested digital broadcast to the requester. By the server broadcaster being able to determine the approximate location of the requesters, the server broadcaster may transmit information, e.g., audio information, over the Internet to users within the defined distribution area thereby ensuring that the distribution base of listeners is limited and subsequently lessening the amount of copyright royalty fees the broadcaster may be required to pay.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates an embodiment of the present invention of a network system;

FIG. 2 illustrates broadcasting radio signals by a radio station in accordance with the present invention;

FIG. 3 illustrates an embodiment of the present invention of a computer system in a network system;

FIG. 4 illustrates an embodiment of the present invention of a server broadcaster in a network system;

FIG. 5 is a flowchart of a method for transmitting a broadcast by a broadcaster over the Internet where only users located approximately with the defined distribution area of the broadcaster are able to interpret the broadcast;

FIG. 6 is a flowchart of a method for transmitting a broadcast over the Internet to only users located approximately with the defined distribution area of the broadcaster; and

FIG. 7 is a flowchart of the sub-steps of the step of determining the approximate physical location of the requester.

### DETAILED DESCRIPTION

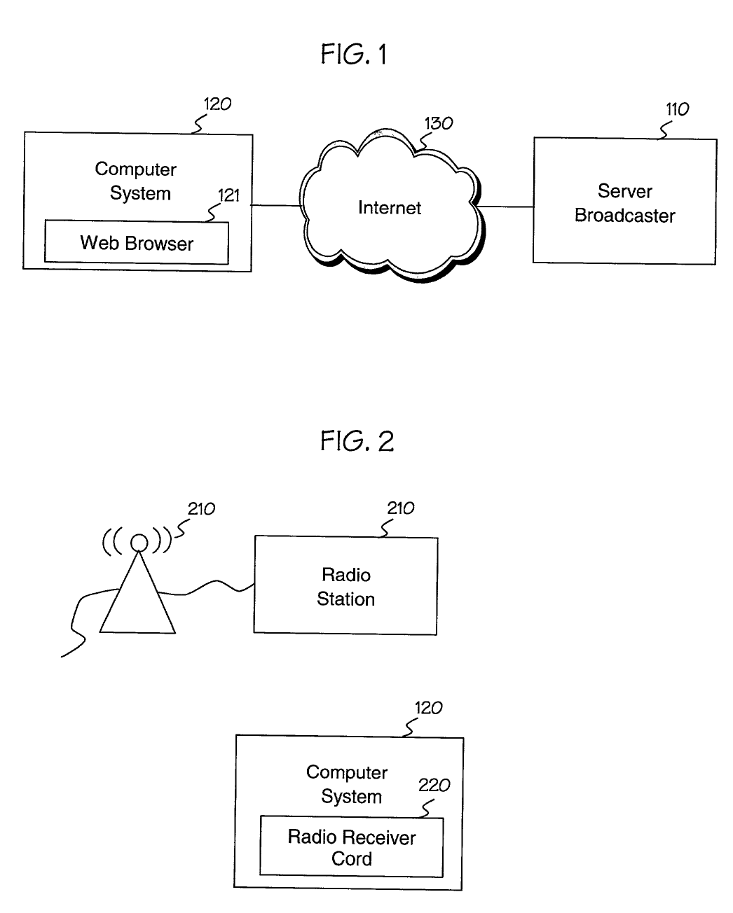

FIG. 1—Network System

FIG. 1 illustrates an embodiment of the present invention of a network system 100. Network system 100 may comprise a server broadcaster 110, e.g., radio station, connected to a computer system 120 commonly referred to as a client via the Internet 130. The Internet 130 may refer to a network of computers. It is noted that network system 100 may comprise a plurality of clients 120 connected to server broadcaster 110 via the Internet 130 and that FIG. 1 is illustrative.

Computer system 120 may comprise a client engine, e.g., web browser 121, which may be configured for communicating with the Internet 130 and for requesting information, e.g., request to transmit a broadcast, from server broadcaster 110. While the illustrated client engine is a web browser 121, those skilled in the art will recognize that other client engines may be used in accordance with the present invention.

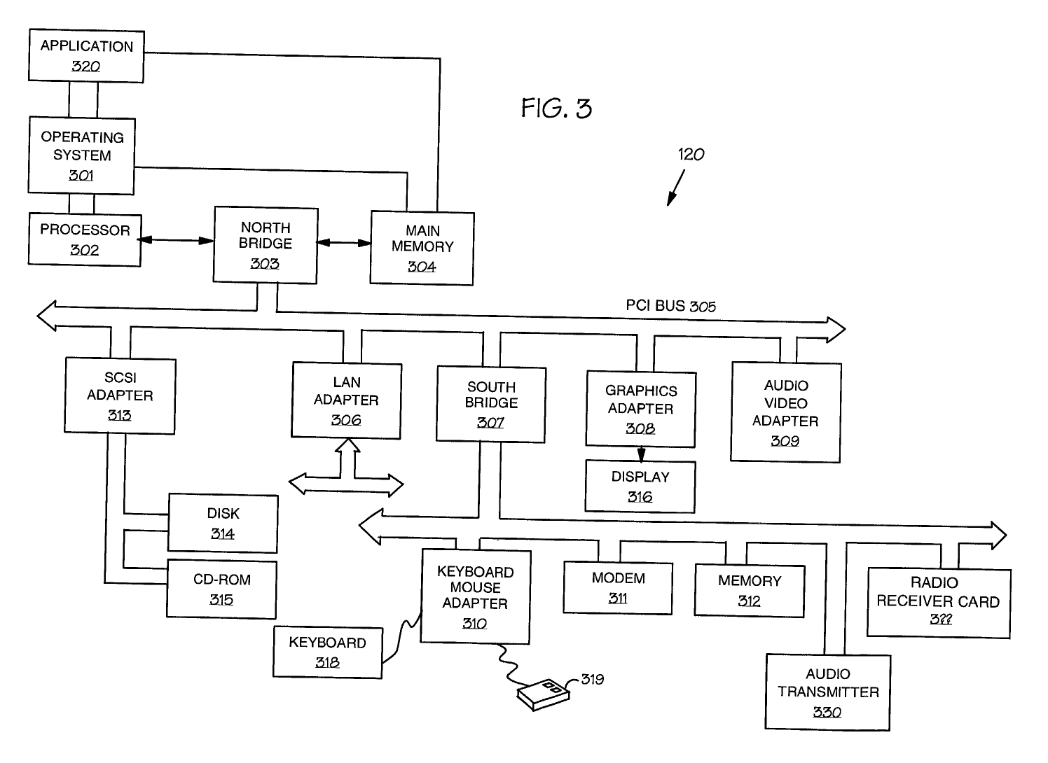

Server broadcaster 110 may be configured to transmit information, e.g., audio information, of a radio broadcast in the form of digital packets over the Internet 130 to web browser 121 of computer system 120. The audio information may be temporarily stored in a buffer (not shown) in computer system 120 before computer system 120 transmits the audio information to a speaker (shown in FIG. 3) thus compensating for momentary delays in packet delivery.

FIG. 2—Radio Broadcast

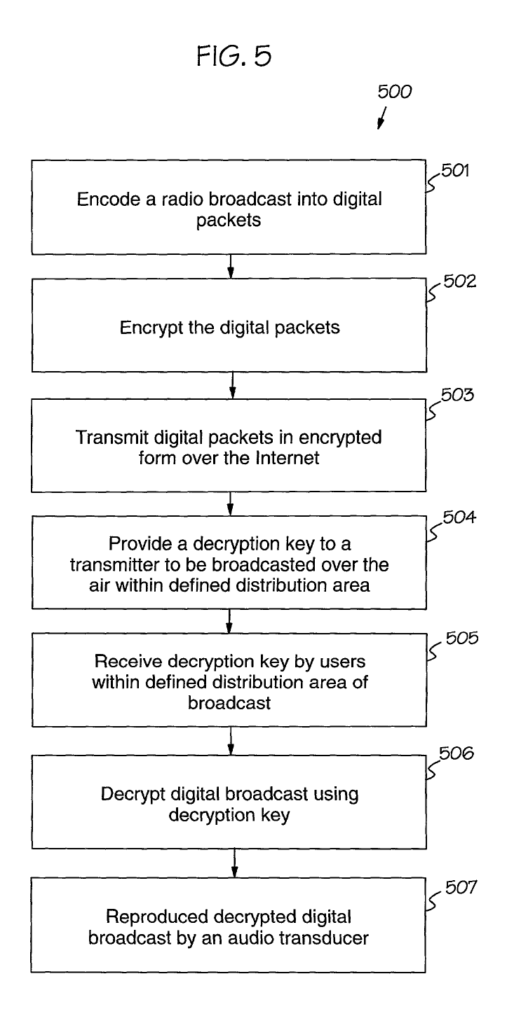

FIG. 2 illustrates an embodiment of the present invention of broadcasting radio signals by a radio station. Radio broadcasting is well known in the art and need not be discussed in great detail. Radio station 210 may broadcast radio signals by transmitting radio signals via antenna 211. Radio station 210 may further be configured to transmit a decryption key via antenna 211 to decrypt an encrypted broadcast transmitted over the Internet 130 as explained in greater detail in the description of FIG. 5. Computer system 120 may be configured to receive the radio broadcast including the decryption key via a radio receiver card 220. Receiver card 220 may be configured to interface with computer system 120 via a standard interface, e.g., Peripheral Component Interconnect (PCI) bus, Industry Standard Architecture (ISA) bus.

FIG. 3—Hardware Configuration of Computer System

FIG. 3 illustrates a typical hardware configuration of computer system 120 which is representative of a hardware environment for practicing the present invention. Computer system 120 may employ a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304, e.g., Dynamic Random Access Memory (DRAM), Synchronous DRAM (SDRAM), may be connected to PCI local bus 305 through north bridge 303. North bridge 303 may also include an integrated memory controller and cache memory for processor 302. Furthermore, an operating system 301 may run on processor 302 to provide control and coordinate the functions of the various components of FIG. 3. An application 320 in accordance with the principles of the present invention may run in conjunction with operating system 301 and provide calls to operating system 301 where the calls implement the various functions or services to be performed by operating system 301 for application 320. An application 330 may include, for example, a program for decrypting an encrypted radio broadcast transmitted by server broadcast 110 as described in the description of FIG. 5, a web browser 121. It should be noted that software components including operating system 301 and application 320 may be loaded into system's main memory 304. Additional components coupled to PCI bus 305 may be made through direct component interconnection or through add-in boards. In the depicted example, Local Area Network (LAN) adapter 306, Small Computer System Interface (SCSI) host bus adapter 313, and south bridge 307 are connected to PCI local bus 305 by direct component connection. In contrast, audio/video adapter 309, graphics adapter 308 are connected to PCI local bus 305 by add-in boards inserted into expansion slots. The processes of the present invention may be used to manage rendering of data by graphics adapter 308 or audio/video adapter 309. Graphics adapter 308 may be provided to control the rendering of text and images on a display 316.

South bridge 307 may provide a connection for a keyboard and mouse adapter 310, modem 311, additional memory 312, audio transducer 330 and radio receiver card 220. Audio transducer 330 may be used to reproduce a digital broadcast as described in conjunction with the description of FIG. 5. Radio receiver card 220 may be configured to receive radio signals transmitted by radio station 210 that may include a decryption key used to decrypt an encrypted radio broadcast transmitted over the Internet 130 as explained in greater detail in the description of FIG. 5. It is noted that the program of the present invention that decrypts an encrypted radio broadcast transmitted by server broadcast 110 as described in the description of FIG. 5 may reside in disk unit 314, CD-ROM 315 or in application 320. A keyboard 318 and a mouse 319 may be connected to keyboard and mouse adapter 310. SCSI host bus adapter 313 may provide a connection for disk drive 314, e.g., hard disk, and CD-ROM drive 315. Typical PCI local bus implementations may support three or four PCI expansion slots or add-in connectors.

Those of ordinary skill in the art will appreciate that the hardware in FIG. 3 may vary depending on the implementation. Other internal hardware or peripheral devices, such as flash ROM (or equivalent non-volatile memory) or optical disk drives and the like, may be used in addition to or in place of the hardware depicted in FIG. 3.

The depicted example in FIG. 3 and the above-described example are not meant to imply architectural limitations. For example, computer system 120 may be a notebook computer or hand held computer in addition to taking the form of a Personal Digital Assistant (PDA). Computer system 120 may also be a kiosk or a Web appliance.

It is noted that implementations of the invention include implementations as a computer system programmed to execute the method or methods described herein, and as a computer program product. According to the computer system implementations, sets of instructions for executing the method or methods may be resident in main memory 304 of one or more computer systems configured generally as described above. Until required by computer system 120, the set of instructions may be stored as a computer program product in another computer memory, for example, in disk unit 314. Furthermore, the computer program product can also be stored at another computer and transmitted when desired to the user's workstation by a network, e.g., LAN, or by an external network such as the Internet. One skilled in the art would appreciate that the physical storage of the sets of instructions physically changes the medium upon which it is stored so that the medium carries computer readable information. The change may be electrical, magnetic, chemical or some other physical change.

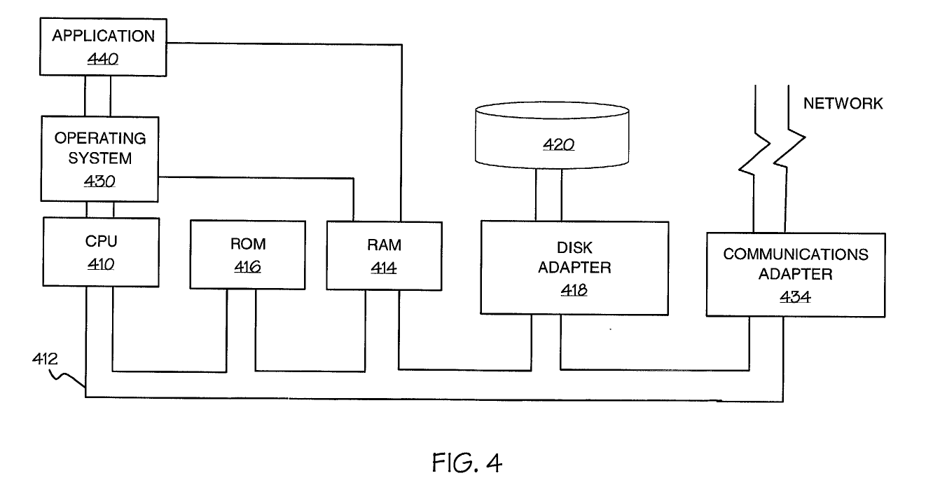

FIG. 4—Hardware Configuration of Server Broadcaster

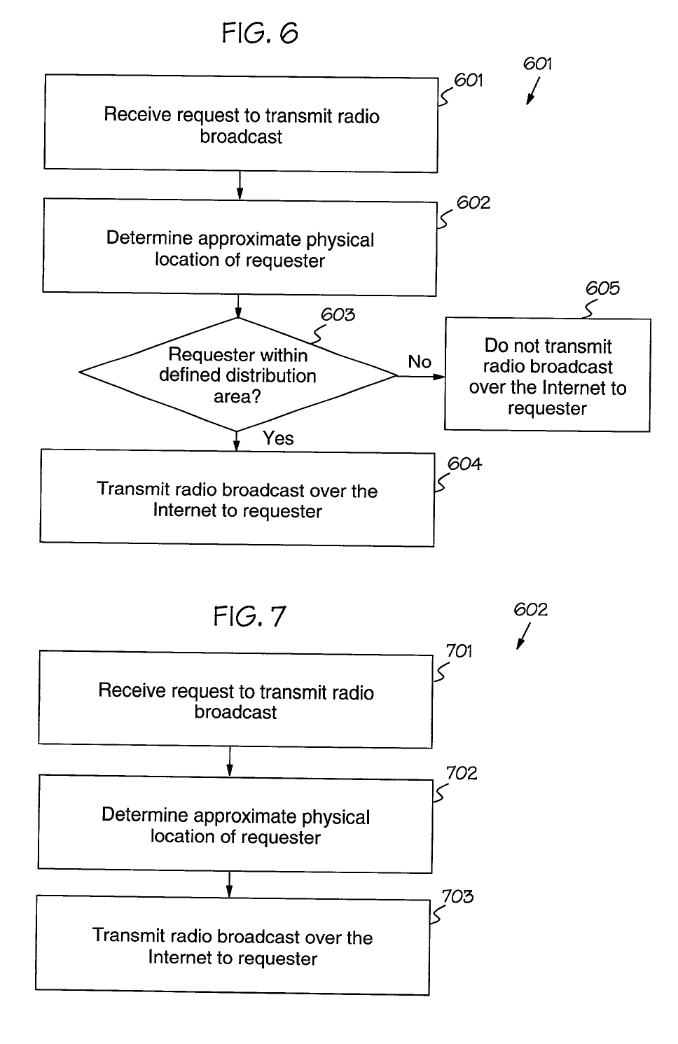

FIG. 4 illustrates an embodiment of the present invention of server broadcaster 110. Referring to FIG. 4, server broadcaster 110 may comprise a central processing unit (CPU) 410 coupled to various other components by system bus 412. An operating system 430 runs on CPU 410 and provides control and coordinates the function of the various components of FIG. 4. An application 440 in accordance with the principles of the present invention may run in conjunction with operating system 430 and provide output calls to operating system 430 where the output calls implement the various functions or services to be performed by application 440. An application 440 may include, for example, a program for encrypting a radio broadcast as well as transmitting the encrypted radio broadcast over the Internet 130 as described in the description of FIG. 5, a program for transmitting a radio broadcast over the Internet 130 to a user of computer system 120 if computer system 120 is located approximately within the defined distribution area of the radio station as described in the description of FIG. 6. Read only memory (ROM) 416 may be coupled to system bus 412 and include a basic input/output system (“BIOS”) that controls certain basic functions of server broadcaster 110. Random access memory (RAM) 414, disk adapter 418 and communications adapter 434 may also be coupled to system bus 412. It should be noted that software components including operating system 440 and application 450 may be loaded into RAM 414 which is the computer system's main memory. Disk adapter 418 may be a small computer system interface (“SCSI”) adapter that communicates with disk units 420, e.g., disk drive. It is noted that the program of the present invention that encrypts a radio broadcast as well as transmits the encrypted radio broadcast over the Internet 130, as described in the description of FIG. 5, may reside in disk unit 420 or application 440. It is further noted that the program of the present invention that transmits a radio broadcast over the Internet 130 to a user of computer system 120 if computer system 120 is located approximately within the defined distribution area of the radio station, as described in the description of FIG. 6, may reside in disk unit 420 or application 440. Communications adapter 434 interconnects bus 412 with an outside network enabling server broadcaster 110 to communicate with computer system 120 via a Defined distribution area Network (LAN), e.g., Ethernet, Token Ring, ARCnet, or a Wide Area Network (WAN), e.g., Internet.

Implementations of the invention include implementations as a computer system programmed to execute the method or methods described herein, and as a computer program product. According to the computer system implementations, sets of instructions for executing the method or methods are resident in the random access memory 414 of one or more computer systems configured generally as described above. Until required by server broadcaster 110, the set of instructions may be stored as a computer program product in another computer memory, for example, in disk drive 420 (which may include a removable memory such as an optical disk or floppy disk for eventual use in disk drive 420). Furthermore, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 5—Method for a Broadcaster to Transmit Audio Information Over the Internet Where Only Users Located Approximately Within a Defined Distribution Area of the Broadcaster are Able to Interpret the Audio Information

FIG. 5 is a flowchart of one embodiment of the present invention of a method 500 for a broadcaster, e.g., radio station, transmitting audio information, e.g., radio broadcast, over the Internet where only users located approximately within a defined distribution area of the broadcaster are able to interpret the information, e.g., listen to the radio broadcast. As stated in the Background Information section, with the advent of the Internet, radio broadcasters have encoded the radio broadcast into digital packets that may then be transmitted through the Internet to various computer users throughout the world. The computer users may then be able to listen to the radio broadcast via speakers on their computer systems. It may be desirable to transmit a radio broadcast over the Internet to improve the quality of the radio broadcast since the broadcast is transmitted over the Internet in digital form instead of audio form (that is, an analog audio modulation) as is the case when the radio broadcast is transmitted over the air. Furthermore, by broadcasting radio signals over the Internet in digital form, the broadcast is more readily amenable to formatting in a visual rendition, thereby allowing a hearing impaired person to visually see the words of the radio broadcast in front of him/her. Radio stations may be required to pay copyright royalties based on the estimated number of listeners which in turn depends on the coverage of the radio broadcast. Furthermore, the amount of money a radio station may be required to pay a disk jockey may also be based on the estimated number of listeners which in turn depends on the coverage of the radio broadcast. Subsequently, radio stations may decide not to transmit radio broadcasts over the Internet because the radio signal may be transmitted all over the world. That is, radio stations may decide not to transmit radio broadcasts over the Internet because the royalty fees may be too large since the estimated number of listeners may be too large. It would therefore be desirable to enable broadcasters, e.g., radio stations, to transmit information, e.g., audio information, over the Internet to a smaller distribution base of listeners thereby lessening the amount of copyright royalty fees the broadcaster may be required to pay. Method 500 is a method for enabling broadcasters, e.g., radio stations, to transmit information, e.g., audio information, over the Internet where only users located approximately within a defined distribution area of the broadcaster may be able to interpret the information, e.g., listen to the radio broadcast.

In step 501, server broadcaster 110 (FIG. 4), e.g., radio station, may encode a radio broadcast to be transmitted over the Internet 130 (FIG. 1) into digital packets of information. Encoding is well known in the art and need not be discussed in detail. It is noted that the various means of encoding a radio broadcast would be recognized by an artisan of ordinary skill in the art and that embodiments employing such means would fall within the scope of the present invention. In one embodiment, more than one type of radio broadcast, e.g., western music, classical music, news, may be encoded to be transmitted over the Internet 130 into digital packets of information.

In step 502, the digital packets of information may then be encrypted by server broadcaster 110. Typically, the digital packets of information may be encrypted by an algorithm, e.g., RC4, using an encryption key. The encrypted digital packets of information may then be decrypted using a decryption key. The decryption key may be mathematically related to the encryption key but extremely difficult to determine even if the encryption key is known. Thus, digital information that is encrypted using the encrypted key may remain secure against anyone but user(s) who hold the decryption key. It is noted that there are numerous means of implementing encryption and that such means would be recognized by an artisan of ordinary skill in the art. It is further noted that embodiments employing such means would fall within the scope of the present invention.

In step 503, server broadcaster 110 may transmit the encrypted digital packets of information over the Internet 130 to be received by users of computer systems 120.

In step 504, a decryption key may be provided to a transmitter 211 (FIG. 2) to be broadcasted over the air with the aid of electromagnetic waves within a defined distribution area. The defined distribution area may be established by the broadcaster as to establish the approximate number of listeners and therefore establish the approximate amount of copyright royalties the broadcaster may be required to pay. In the embodiment where multiple types of encoded broadcasts are transmitted over the Internet 130, multiple decryption keys may be provided to transmitter 211 to be broadcasted over the air with the aid of electromagnetic waves within a defined distribution area thereby allowing recipients of the multiple decryption keys that are located within the defined distribution area the ability to decrypt a particular broadcast of interest, e.g., news, as explained in greater detail below.

In step 505, users of computer systems 120 (FIG. 3) that are located approximately within the defined distribution area of radio station 210 that transmitted the decryption key in step 504 may receive the decryption key via radio receiver card 220. Since radio station 210 may transmit a radio broadcast including the decryption key only within the defined distribution area, users of computer systems 120 that are located approximately beyond the defined distribution area of radio station 210 may not be able to receive the decryption key. Subsequently, only those authorized users, i.e., those users of computer systems 120 located approximately within the defined distribution area of radio station 210, may be able to receive the decryption key and hence decrypt the encrypted digital packets of information as described below.

In step 506, authorized users, i.e., those users of computer systems 120 that received the decryption key in step 505, may decrypt the received encrypted digital packets of information. By radio station 210 transmitting a decryption key within the defined distribution area as defined, only users of computer systems 120 located approximately within that area will be able to receive the decryption key and hence decrypt the encrypted digital packets of information. In one embodiment, authorized users may select a particular decryption key out of the multiple decryption keys received thereby being able to decrypt a particular broadcast of interest, e.g., news, out of the multiple broadcasts transmitted over the Internet 130.

In step 507, the decrypted broadcast may be reproduced by an audio transducer 330 of computer system 120 thereby allowing the user of computer system 120 to listen to the digital broadcast. Thus, radio station 210 may be able to transmit a radio broadcast via the Internet 130 and ensure that only users located approximately within the defined distribution area of radio station 210 will be able to hear the digital broadcast transmitted over the Internet 130.

It is noted that method 500 may be executed in a different order presented and that the order presented in the discussion of FIG. 5 is illustrative. It is further noted that certain steps may be executed almost concurrently. It is further noted that steps 501-504 may be implemented by a program in server broadcaster 110 residing in application 440 (FIG. 4) or disk unit 420 (FIG. 4). It is further noted that steps 505-507 may be implemented by a program in computer system 120 located approximately within the defined distribution area of the broadcaster that transmitted the decryption key in step 504. The program in computer system 120 that implements steps 505-507 may reside in application 320 (FIG. 3), disk unit 314 (FIG. 3) or CD-ROM 315 (FIG. 3).

FIG. 6—Method for a Broadcaster to Transmit Audio Information over the Internet within a Defined Distribution Area of the Broadcaster

Method 600 is a method for enabling broadcasters, e.g., radio stations, to transmit information, e.g., audio information, over the Internet within a defined distribution area of the broadcaster. As stated above, radio stations may be required to pay copyright royalties based on the estimated number of listeners which in turn depends on the coverage of the radio broadcast. Subsequently, radio stations may decide not to transmit radio broadcasts over the Internet because the radio signal may be transmitted all over the world. That is, radio stations may decide not to transmit radio broadcasts over the Internet because the royalty fees may be too large since the estimated number of listeners may be too large. It would therefore be desirable to enable broadcasters, e.g., radio stations, to transmit information, e.g., audio information, over the Internet to a smaller distribution base of listeners thereby lessening the amount of copyright royalty fees the broadcaster may be required to pay. Method 600 is a method for enabling broadcasters, e.g., radio stations, to transmit information, e.g., audio information, over the Internet within a defined distribution area of the broadcaster thereby lessening the amount of copyright royalty fees the broadcaster may be required to pay.

In step 601, server broadcaster 110, e.g., radio station, may receive a request from a user of computer system 120 to access server broadcaster 110 to listen to a particular radio broadcast. That is, server broadcaster 110 may receive a request from a user of computer system 120 to transmit a radio broadcast over the Internet 130 to the user of computer system 120.

In step 602, server broadcaster 110 may determine an approximate physical location of the requester. Step 602 may comprise sub-steps as illustrated in FIG. 7.

Referring to FIG. 7, server broadcaster 110 may capture the Internet Protocol (IP) address of the requester in step 701. Upon capturing the IP address of the requester, server broadcaster 110 may convert the captured IP address of the requester into a computer name, e.g., convert 206.156.18.122 into www.consumer.net in step 702. Upon converting the IP address of the requester into a computer name, a trace may be performed to determine the approximate physical location of the requester in step 703. Typically, a request travels through the Internet 130 through several computers in a hierarchical fashion. Normally, a request is passed from the requester to their Internet Service Provider (ISP) until it reaches the requester's “backbone” provider. The request may then be transferred to the ISP of the destination and finally to the intended recipient, i.e., server broadcaster 110. By tracing the path of the request as outlined above, the approximate physical location of the requester may be determined.

Referring to FIG. 6, in step 603, server broadcaster 110 may determine if the requester is physically located approximately within a defined distribution area of server broadcaster 110. The defined distribution area may be established by the broadcaster as to establish the approximate number of listeners and therefore establish the approximate amount of copyright royalties the broadcaster may be required to pay.

If the requester is physically located approximately within the defined distribution area of server broadcaster 110, e.g., radio station, then server broadcaster 110 may transmit the requested radio broadcast over the Internet to the requester in step 604.

If the requester is not physically located approximately within the defined distribution area of server broadcaster 110, e.g., radio station, then server broadcaster 110 may not transmit the requested radio broadcast over the Internet to the requester in step 605.

By server broadcaster 110, e.g., radio station, being able to determine the approximate physical location of requesters, server broadcaster 110 may transmit information, e.g., audio information, over the Internet 130 to users within the defined distribution area.

It is noted that method 600 may be executed in a different order presented and that the order presented in the discussion of FIG. 6 is illustrative. It is further noted that certain steps in method 600 may be executed almost concurrently. It is further noted that the sub-steps of step 602 may be executed in a different order presented and that the order presented in the discussion of FIG. 7 is illustrative. It is further noted that certain sub-steps of step 602 may be executed almost concurrently. It is further noted that steps 601-605 of method 600 and sub-steps 701-703 of step 602 of method 600 may be implemented by a program in server broadcaster 10 residing in application 440 (FIG. 4) or disk unit 420 (FIG. 4).

Although the system, method and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for transmitting a broadcast over the Internet by a broadcaster where the broadcast is interpreted by users located approximately within a defined distribution area of the broadcaster, comprising the steps of:
encoding a radio broadcast into digital packets of information;
encrypting said digital packets of information;
transmitting said encrypted digital packets of information over the Internet; and
providing a decryption key to a transmitter to be broadcasted within said defined distribution area of said broadcaster.

2. The method as recited in claim 1 further comprising the step of:
receiving said decryption key by one or more users of computer systems located approximately within said defined distribution area of said broadcaster.

3. The method as recited in claim 2 further comprising the step of:
decrypting said encrypted digital packets of information using said decryption key.

4. The method as recited in claim 3 further comprising the step of:
reproducing said decrypted digital broadcast by an audio transducer.

5. The method as recited in claim 1, wherein said decryption key is transmitted via electromagnetic waves within said defined distribution area of said broadcaster.

6. A computer program product embodied in a machine readable medium for transmitting a broadcast over the Internet by a broadcaster where the broadcast is interpreted by users located approximately within a defined distribution area of the broadcaster comprising the programming steps of:
encoding a radio broadcast into digital packets of information;
encrypting said digital packets of information;
transmitting said encrypted digital packets of information over the Internet; and
providing a decryption key to a transmitter to be broadcasted within said defined distribution area of said broadcaster.

7. The computer program product as recited in claim 6 further comprises the programming step of:
receiving said decryption key by one or more users of computer systems located approximately within said defined distribution area of said broadcaster.

8. The computer program product as recited in claim 7 further comprises the programming step of:
decrypting said encrypted digital packets of information using said decryption key.

9. The computer program product as recited in claim 8 further comprises the programming step of:
reproducing said decrypted digital broadcast by an audio transducer.

10. The computer program product as recited in claim 6, wherein said decryption key is transmitted via electromagnetic waves within said defined distribution area of said broadcaster.

11. A system, comprising:
a server broadcaster configured to transmit a broadcast over the Internet, wherein said server broadcaster comprises:
a processor; and
a memory unit coupled to said processor, wherein said memory unit is operable for storing a computer program operable for transmitting a broadcast over the Internet, wherein said broadcast is interpreted by users located approximately within a defined distribution area of said server broadcaster, wherein the computer program is operable for performing the following programming steps:
encoding a radio broadcast into digital packets of information;
encrypting said digital packets of information; and
transmitting said encrypted digital packets of information over the Internet; and
providing a decryption key to a transmitter to be broadcasted via radio frequencies within said defined distribution area of said server broadcaster.

12. The system as recited in claim 11 further comprising:
one or more computer systems coupled to said server broadcaster, wherein one or more of said one or more computer systems are located approximately within said defined distribution area of said server broadcaster, wherein each of said one or more computer systems located approximately within said defined distribution area of said server broadcaster comprises:
a processor; and
a memory unit coupled to said processor, wherein said memory unit is operable for storing a computer program, wherein the computer program is operable for performing the following programming step:
receiving said decryption key.

13. The system as recited in claim 12, wherein the computer program in each of said one or more computer systems located approximately within said defined distribution area of said server broadcaster is further operable for performing the following programming step:
decrypting said encrypted digital packets of information using said decryption key.

14. The system as recited in claim 13, wherein the computer program in each of said one or more computer systems located approximately within said defined distribution area of said server broadcaster is further operable for performing the following programming step:
reproducing said decrypted digital broadcast by an audio transducer.

15. The system as recited in claim 11, wherein said decryption key is transmitted via electromagnetic waves within said defined distribution area of said server broadcaster.

16. A method for transmitting a broadcast over the Internet within a defined distribution area, comprising the steps of:
receiving a request to transmit said broadcast from a requester;
determining an approximate physical location of said requester; and
transmitting said broadcast over the Internet to said requester if said requester is physically located approximately within said defined distribution area.

17. The method as recited in claim 16, wherein said step of determining said approximate physical location of said requester comprises the steps of:
capturing an Internet Protocol of said requester;
converting said captured Internet Protocol of said requester into a computer name; and
performing a trace of said request.

18. The method as recited in claim 16, wherein said broadcast is not transmitted over the Internet to said requester if said requester is physically located approximately outside said defined distribution area.

19. A computer program product embodied in a machine readable medium for transmitting a broadcast over the Internet within a defined distribution area comprising the programming steps of:
receiving a request to transmit said broadcast from a requester;
determining an approximate physical location of said requester; and
transmitting said broadcast over the Internet to said requester if said requester is physically located approximately within said defined distribution area.

20. The computer program product as recited in claim 19, wherein said programming step of determining said approximate physical location of said requester comprises the programming steps of:
capturing an Internet Protocol of said requester;
converting said captured Internet Protocol of said requester into a computer name; and
performing a trace of said request.

21. The computer program product as recited in claim 19, wherein said broadcast is not transmitted over the Internet to said requester if said requester is physically located approximately outside said defined distribution area.

22. A system, comprising:
a processor; and
a memory unit coupled to said processor, wherein said memory unit is operable for storing a computer program operable for transmitting a broadcast over the Internet within a defined distribution area, wherein the computer program is operable for performing the following programming steps:
receiving a request to transmit said broadcast from a requester;
determining an approximate physical location of said requester; and
transmitting said broadcast over the Internet to said requester if said requester is physically located approximately within said defined distribution area.

23. The system as recited in claim 22, wherein said programming step of determining said approximate physical location of said requester comprises the programming steps of:
capturing an Internet Protocol of said requester;
converting said captured Internet Protocol of said requester into a computer name; and
performing a trace of said request.

24. The system as recited in claim 22, wherein said broadcast is not transmitted over the Internet to said requester if said requester is physically located approximately outside said defined distribution area.
